(19) United States
(12) Patent Application Publication
(10) Pub. No.: US 2026/0037179 A1
(43) Pub. Date: Feb. 5, 2026

(54) DATA STORAGE APPARATUS FOR MANAGING WRITE DATA HAVING OVERLAPPED LOGICAL ADDRESS, OPERATION METHOD THEREOF, AND MEMORY CONTROLLER

(71) Applicant: SK hynix Inc., Gyeonggi-do (KR)

(72) Inventors: Seung Hun JI, Gyeonggi-do (KR); Young Ho AHN, Gyeonggi-do (KR)

(21) Appl. No.: 19/232,868

(22) Filed: Jun. 10, 2025

(30) Foreign Application Priority Data
Jul. 31, 2024 (KR) 10-2024-0101882
Jan. 8, 2025 (KR) 10-2025-0002984

(51) Int. Cl. G06F 3/06

(52) U.S. Cl. CPC G06F 3/0656; G06F 3/0619; G06F 3/0659; G06F 3/0688

(57) ABSTRACT

A data storage apparatus includes a storage medium and a memory controller. The memory controller may change a buffering address of write data to an address in which new write data is stored when a new write request for the same logical address as a logical address of cached old write data is received and the old write data is not yet programed.

### CROSS-REFERENCES TO RELATED APPLICATIONS

The present application claims priority under 35 U.S.C. § 119(a) to Korean Patent Application Numbers 10-2024-0101882, filed on Jul. 31, 2024 and 10-2025-0002984, filed on Jan. 8, 2025, which are incorporated herein by reference in their entirety.

### BACKGROUND

### 1. Technical Field

Various embodiments generally relate to a semiconductor integrated apparatus, and more particularly, to a data storage apparatus for managing write data having an overlapped logical address, an operation method thereof, and a memory controller therefor.

### 2. Related Art

A data storage apparatus may store data in a memory device or read data stored in the memory device and provide the read data to the external apparatus, in response to a request of the external apparatus.

The performance of the data storage apparatus may depend on the data write/read speed of the memory device as well as the technique in which a memory controller operates the memory device.

Consequently, there is a desire for technology that increases the efficient writing or reading of data in response to a request of an external apparatus.

### SUMMARY

Embodiments of the present disclosure provide a data storage apparatus in which data is not unnecessarily programmed, an operation method thereof, and a memory controller therefor.

In an embodiment of the present disclosure, a data storage apparatus may include a storage medium; and a memory controller. The memory controller may be configured to change, when a first write command including a same logical address as a logical address of old write data buffered in a buffer memory device is received, and the old write data is not yet transmitted to the storage medium, first buffering information including a first buffering address of the old write data to include a second buffering address of first write data related to the first write command, and generate a program command including, as second buffering information, the second buffering address.

In an embodiment of the present disclosure, a memory controller may include: a first core; and a second core. The first core may be configured to buffer write data, generate a write descriptor including first buffering information related to a buffering address of the write data, and change, when the old write data having a same logical address as a logical address included in a first write command is buffered, first buffering information of a write descriptor related to the old write data to include a buffering address of first write data related to the first write command based on a flag. The second core may be configured to generate a program command including, as second buffering information, the buffering address of the first write databased on the write descriptor, transmit write data corresponding to the second buffering information to a storage medium, and set the flag.

In an embodiment of the present disclosure, an operating method of a data storage apparatus, including a storage medium and a memory controller, may include confirming, by the memory controller, whether the old write data is transmitted to the storage medium in response to a first write command including a same logical address as a logical address of the old write data buffered in a buffer memory device. The method may further include in response to a determination that the old write data is not yet transmitted to the storage medium, changing, by the memory controller, first buffering information including a first buffering address of the old write data to include a second buffering address of first write data related to the first write command. The method may further include generating, by the memory controller, a program command including the first buffering address as second buffering information.

According to the present technology, write data for an overlapped logical address may not be unnecessarily programmed in a storage medium.

Accordingly, waste of the storage medium may be suppressed and ageing speed of the storage medium may be slowed down.

These and other features, aspects, and embodiments are described in more detail below.

### BRIEF DESCRIPTION OF THE DRAWINGS

The above and other aspects, features and advantages of the subject matter of the present disclosure will be more clearly understood from the following detailed description taken in conjunction with the accompanying drawings, in which:

FIG. 1 is a diagram illustrating a configuration of a data processing system according to an embodiment of the present disclosure;

FIG. 2 is a diagram illustrating a configuration of a memory controller according to an embodiment of the present disclosure;

FIG. 3 is a diagram for describing a buffer memory device according to an embodiment of the present disclosure;

FIG. 4 is a diagram for describing a first core according to an embodiment of the present disclosure;

FIG. 5 is a diagram for describing a write descriptor according to an embodiment of the present disclosure;

FIG. 6 is a diagram for describing a second core according to an embodiment of the present disclosure;

FIG. 7 is a diagram for describing a verification circuit according to an embodiment of the present disclosure; and

FIG. 8 is a diagram for describing an operating method of a data storage apparatus according to an embodiment of the present disclosure.

### DETAILED DESCRIPTION

Various embodiments of the present teachings are described in detail with reference to the accompanying drawings. The drawings are schematic illustrations of various embodiments (and intermediate structures). As such, variations from the configurations and shapes of the illustrations as a result, for example, of manufacturing techniques and/or tolerances, are to be expected. Thus, the described embodiments should not be construed as being limited to the particular configurations and shapes illustrated herein but may include deviations in configurations and shapes which do not depart from the spirit and scope of the present teachings as defined in the appended claims.

The present teachings are described herein with reference to cross-section and/or plan illustrations of idealized embodiments of the present teachings. However, embodiments of the present teachings should not be construed as limiting the present teachings. Although a few embodiments of the present teachings are shown and described, it will be appreciated by those of ordinary skill in the art that changes may be made in these embodiments without departing from the principles and spirit of the present teachings.

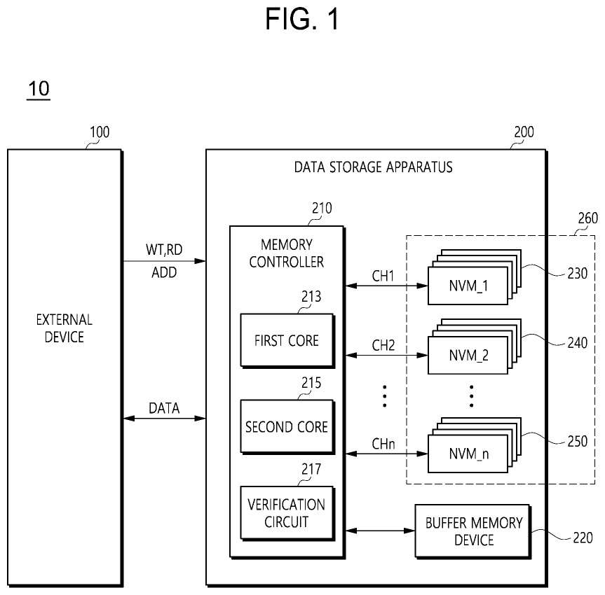

FIG. 1 is a diagram illustrating a configuration of a data processing system according to an embodiment of the present disclosure.

Referring to FIG. 1, a data processing system 10 includes an external apparatus 100 and a data storage apparatus 200.

The external apparatus 100 may include at least one processor. The external apparatus 100 may be a processor itself or an electronic device or system including a processor. The external apparatus 100 may operate as a host apparatus for the data storage apparatus 200.

The data storage apparatus 200 includes a memory controller 210, a buffer memory device 220, and a storage medium 260. The storage medium 260 includes at least a plurality of nonvolatile memory devices (NVM_1, NVM_2, . . . , NVM_n) 230, 240, . . . , 250 electrically coupled to the memory controller 210 through at least one channel CH1, CH2, . . . , CHn.

The external apparatus 100 may transmit a write request including a write command WT, an address ADD, and write data DATA to the data storage apparatus 200 to write data. In response to the write request, the data storage apparatus 200 may control the write data to be programmed in the storage medium 260.

The external apparatus 100 may transmit a read request including a read command RD and an address ADD to the data storage apparatus 200 to read data. The data storage apparatus 200 may read the read-requested data DATA from the storage medium 260 and transmit the read data DATA to the external apparatus 100.

The data storage apparatus 200 may read data from the storage medium 260 or write data in the storage medium 260 to perform the read and write requests of the external apparatus 100 as well as to perform a read or write request which is internally generated to perform an internal management operation for managing the storage medium 260. The internal management operation may include a house keeping operation which is performed regardless of a request of the external apparatus 100 so as to efficiently use a storage space of the storage medium 260 or ensure the reliability of data stored in the storage medium 260, for example, a garbage collection operation, a wear leveling operation, a read reclaim operation, and the like.

In an embodiment, the storage medium 260 may include at least one of various types of nonvolatile memory devices 230 to 250 such as a NAND flash memory device, a NOR flash memory device, a ferroelectric random access memory (FRAM) using a ferroelectric capacitor, a magnetic RAM (MRAM) using a tunneling magneto-resistive (TMR) layer, a phase-change RAM (PRAM) using a chalcogenide alloy, and a resistive RAM (RERAM) using a transition metal oxide.

Each of the nonvolatile memory devices 230 to 250 may include a plurality of memory cells. Each of the memory cells may operate as a single level cell (SLC) which stores 1-bit data or a multi-level cell (MLC) which stores 2-bit or more data. Portions of the nonvolatile memory devices 230 to 250 may be configured to operate as SLC memory devices, and the remaining nonvolatile memory devices may be configured to operate as MLC memory devices. Portions of the memory cells in each of the nonvolatile memory devices 230 to 250 may operate as SLCs, and the remaining memory cells in each of the nonvolatile memory devices 230 to 250 may operate as MLCs.

The buffer memory device 220 may temporarily store data transmitted and received between the memory controller 210 and the data storage apparatus 200 in a read or write operation. In some embodiments, the data storage apparatus 200 may be a DRAM-less apparatus in which the buffer memory device 220 is not included. The buffer memory device 220 may be included in the inside of the memory controller 210.

The buffer memory device 220 may temporarily store system data, for example, a descriptor related to a request of the external apparatus 100, mapdata for data stored in the storage medium 260, and the like. In the DRAM-less apparatus, the system data may be stored in a memory of the inside of the memory controller 210 or a memory of the external apparatus 100.

The descriptor may be a statement of works which includes information required for processing a request received from the external apparatus 100 through the memory controller 210.

The mapdata may be a collection of mapping information between an address (i.e., physical address) of a physical storage space constituting the storage medium 260 and a logical address assigned to the storage medium 260 by the external apparatus 100. The mapdata may be stored in the storage medium 260, and the memory controller 210 may at least partially load and use the mapdata required for the operation of the data storage apparatus 200 to the buffer memory device 220 or an internal memory (not shown) of the memory controller 210.

In response to a first write command including a same logical address as a logical address of old write data buffered in the buffer memory device 220, the memory controller 210 may change first buffering information including a first buffering address stored in a write descriptor of the old write data to a second buffering address of first write data related to the first write command when the old write data is not transmitted to the storage medium 260, and generate a program command including, as second buffering information, the second buffering address.

After transmitting the write data to the storage medium 260, the memory controller 210 may set a flag to manage whether or not the write data is transmitted to the storage medium 260.

The memory controller 210 may compare the second buffering information included in the program command and the first buffering information stored in the write descriptor related to the program command and change the second buffering information to the first buffering information when the second buffering information is different from the first buffering information.

The memory controller 210 includes a first core 213, a second core 215, and a verification circuit 217.

In response to the write request of the external apparatus 100, the first core 213 may buffer the write data and generate the write descriptor. The write descriptor may include the first buffering information which is an address in which the write data related to the write command is buffered. When the old write data of the same logical address as a logical address included in a new write request is stored (i.e., buffered) in the buffer memory device 220, the first core 213 may omit (i.e., skip) the generation of the write descriptor for the new write request and update a buffering address of write data included in the new write request as the first buffering information to the write descriptor related to the old write data.

The second core 215 may generate the program command based on the write descriptor related to the write command to be processed. The program command may include the second buffering information which is the address in which the write data is buffered. The second core 215 may transmit the program command and the write data according to the second buffering information to the storage medium 260 and set the flag to a write descriptor related to the program command. For example, the flag may indicate whether or not the write data related to the corresponding write descriptor is transmitted to the storage medium 260.

The verification circuit 217 may compare a buffering address indicated by the second buffering information included in the program command generated in the second core 215 and a buffering address indicated by the first buffering information included in the write descriptor related to the program command. When the first buffering information and the second buffering information are different from each other, the verification circuit 217 may provide the buffering address indicated by the first buffering information to the second core 215.

Accordingly, the first core 213 may store the old write data for an old write request in a region corresponding to the first buffering address and generate the write descriptor including the first buffering address as the first buffering information.

The second core 215 may generate the program command including the first buffering address as the second buffering information based on the write descriptor, transmit the write data stored in the first buffering address to the storage medium 260, and set the flag.

In this instance, the second buffering information included in the program command is the same as the first buffering information included in the write descriptor, and thus the verification circuit 217 may not provide a new buffering position to the second core 215.

Before the first core 213 generates the write descriptor including the first buffering address as the first buffering information in response to the old write request and the second core 215 transmits the write data to the storage medium 260, a new write request for the same logical address as the logical address included in the old write request may be received from the external apparatus 100. In this instance, the old (or first) write data may not have yet been transmitted from the second core 215 to the storage medium 260, and thus the flag may not be in a set state.

The flag is not set, and thus the first core 213 may determine that the write data related to the old write request is not yet transmitted to the storage medium 260. The first core 213 may store the write data included in the new write request in a region corresponding to the second buffering address and change the first buffering information from the first buffering address to the second buffering address in the write descriptor for the old write request.

The second core 215 may generate the program command including the second buffering address acquired in the write descriptor as the second buffering information.

In this instance, the second buffering information included in the program command may be the same as the first buffering information of the write descriptor, and thus the verification circuit 217 may not provide the new buffering position to the second core 215.

Accordingly, other than the old write data of the first buffering address, the new write data stored in the second buffering address may be programmed in the storage medium 260.

Before the program command including the second buffering information as the first buffering address is generated and the flag is set in the second core 215, the first buffering information of the write descriptor may be changed to a third buffering address by the first core 213.

In this case, the second buffering information included in the program command is different from the first buffering information of the write descriptor, and thus the verification circuit 217 may provide the third buffering address as new buffering information to the second core 215.

Accordingly, the second core 215 may read new write data from a region corresponding to the third buffering address and transmit the new write data to the store medium 260, and the new write data stored in the third buffering address may be programmed in the storage medium 260.

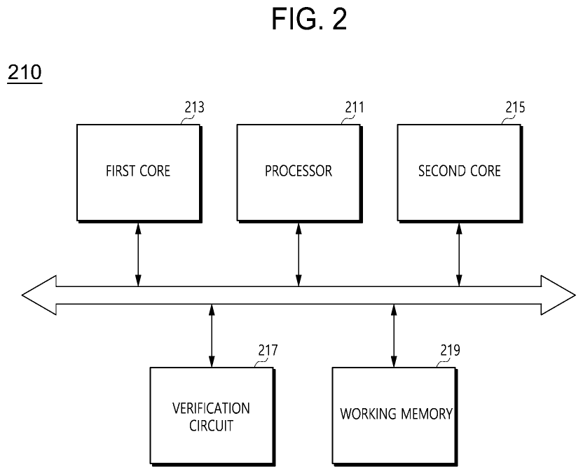

FIG. 2 is a configuration diagram of a memory controller according to an embodiment of the present disclosure.

Referring to FIG. 2, the memory controller 210 includes a processor 211, the first core 213, the second core 215, the verification circuit 217, and a working memory 219.

The processor 211 may be configured to operate as firmware or software provided for various operations of the memory controller 210 is executed on hardware. The processor 211 may be configured in a combined form of hardware and firmware or software which operates on the hardware. The processor 211 may perform a function of a flash translation layer (FTL), which manages the data storage apparatus 200, and the like.

The first core 213 may receive a command and a clock signal from the external apparatus 100 and provide a communication channel for controlling data input and output according to control of the processor 211. The first core 213 may provide a physical connection between the external apparatus 100 and the data storage apparatus 200.

In an embodiment, the first core 213 may communicate with the external apparatus 100 based on an interface using at least one among various interface protocols such as a universal serial bus (USB) protocol, a multimedia card (MMC) protocol, a peripheral component interconnection (PCI) protocol, a PCI-express (PCI-E) protocol, an advanced technology attachment (ATA) protocol, a serial advanced technology attachment (SATA) protocol, a parallel advanced technology attachment (PATA) protocol, a small computer system interface (SCSI) protocol, an enhanced small disk interface (ESDI) protocol, an integrated drive electronics (IDE) protocol, a private protocol, a system management bus (SMBus) protocol, an inter-integrated circuit (I2C) protocol, and an improved inter-integrated circuit (I3C) protocol.

The first core 213 may interpret and store a command included in a request received from the external apparatus 100. In response to the write request of the external apparatus 100, the first core 213 may queue the write command in the working memory 219 and generate the write descriptor according to control of the processor 211. The first core 213 may store the write descriptor and the write data in the buffer memory device 220. The write descriptor may include the buffering address, in which the write data related to the write request is buffered, as the first buffering information.

The first core 213 may manage the first buffering information included in the write descriptor based on the logical address included in the write request of the external apparatus 100 and the flag set by the second core 215.

The second core 215 may provide a communication channel for signal transmission and reception between the memory controller 210 and the storage medium 260. The second core 215 may transmit the data temporarily stored in the buffer memory device 220 to the storage medium 260 according to control of the processor 211. The second core 215 may transmit the read data that is read from the storage medium 260 to the buffer memory device 220 to be temporarily stored therein according to control of the processor 211.

The second core 215 may generate the program command based on the write descriptor generated in the first core 213, provide the program command to the storage medium 260, and set the flag according to control of the processor 211. The program command may include the buffering address, in which the write data is buffered, as the second buffering information.

The second core 215 may transmit the write data stored in the buffer memory device 220 to the storage medium 260 according to the second buffering information included in the program command.

In instances in which the first buffering information of the write descriptor is different from the second buffering information of the program command, the verification circuit 217 may provide the first buffering information to the second core 215 to correct a buffering position of the write data.

The working memory 219 may be configured of a random access memory device such as a dynamic random access memory (DRAM) or a static random access memory (SRAM). The working memory 219 may cache data stored in the buffer memory device 220.

The working memory 219 may store the firmware driven by the processor 211. Further, the working memory 219 may store data required for driving of the firmware, for example, metadata. The metadata may be stored in the storage medium 260, and the processor 211 may load and use the metadata required for an operation of the data storage apparatus 200 to the working memory 219.

The working memory 219 may operate as a buffer memory configured to store write data provided from the external apparatus 100 and the read data that is read from the storage medium 260.

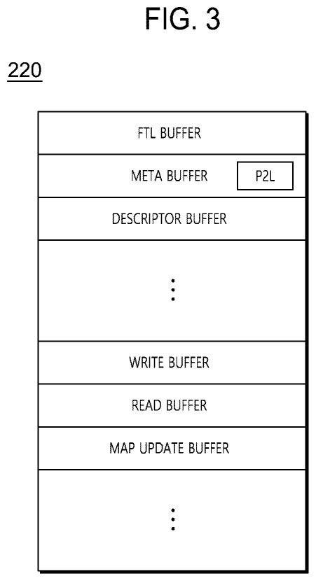

FIG. 3 is a diagram for describing a buffer memory device according to an embodiment of the present disclosure.

Referring to FIG. 3, the buffer memory device 220 according to an embodiment includes a flash translation layer (FTL) buffer FTL BUFFER in which the FTL is stored, a metadata buffer META BUFFER, a descriptor buffer DESCRIPTOR BUFFER, a write buffer WRITE BUFFER, a read buffer READ BUFFER, and a map update buffer MAP UPDATE BUFFER.

The FTL may be software driven by the memory controller 210, and the memory controller 210 may drive the FTL to control a unique operation of the data storage apparatus 200 and provide apparatus compatibility to the external apparatus 100. Through the driving of the FTL, the external apparatus 100 may recognize and use the data storage apparatus 200 as a storage apparatus such as a disc.

The FTL may include a read module, a write module, a garbage collection module, a wear-levelling module, a bad block management module, a map module, and the like. The FTL may be stored in a system region (not shown) of the storage medium 260, and when data storage apparatus 200 is powered on, the FTL may be read from the system region of the storage medium 260 and loaded to the buffer memory device 220.

The FLT loaded to the buffer memory device 220 may be loaded to the working memory 219 of the memory controller 210.

Meta information such as a physical to logical (P2L) table may be stored in the metadata buffer META BUFFER.

Various descriptors generated to process the request of the external apparatus 100, for example, the write descriptor generated in the first core 213 and the like may be stored in the descriptor buffer DESCRIPTOR BUFFER.

The write data which is to be transmitted from the external apparatus 100 to the storage medium 260 may be temporarily stored in the write buffer WRITE BUFFER.

The read data which is read from the storage medium 260 and is to be transmitted to the external apparatus 100 may be temporarily stored in the read buffer READ BUFFER.

A map segment to be uploaded out of mapping information may be temporarily stored in the map update buffer MAP UPDATE BUFFER.

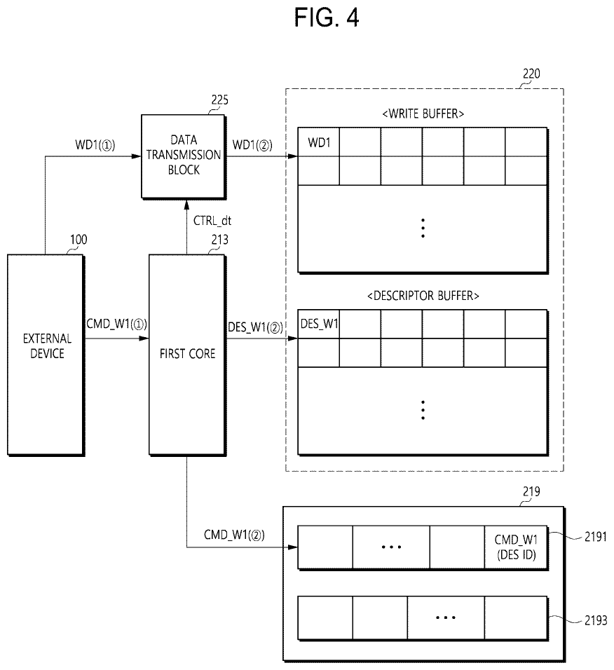

FIG. 4 is a diagram for describing a first core according to an embodiment of the present disclosure.

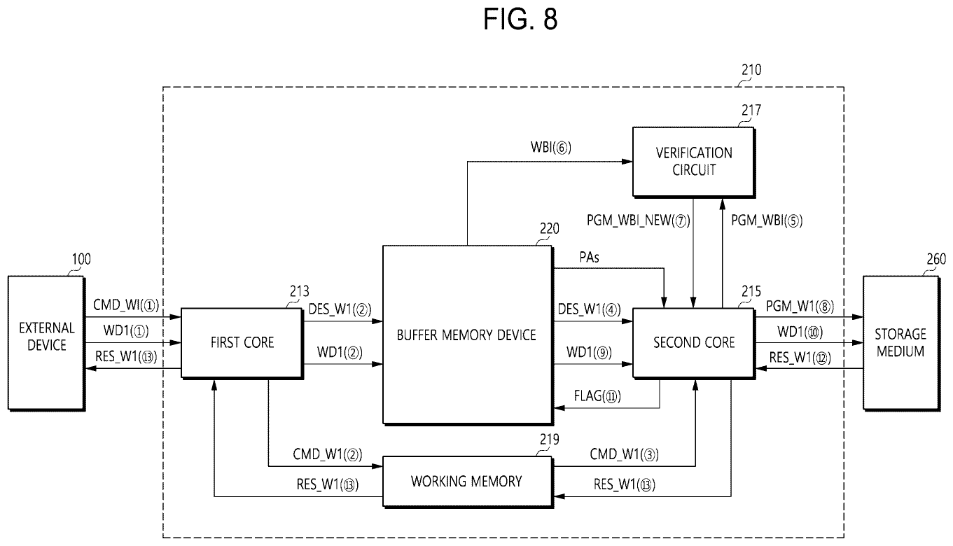

Referring to FIG. 4, when a first write command CMD_W1 and first write data WD1 are received from the external apparatus 100 (\textcircled{1}) (wherein the bracketed encircled numbers indicate steps of a method of operation of the memory apparatus as described in detail herein below with respect to FIG. 8), the first core 213 may confirm whether or not write data of an old write command related to the same logical address as a logical address included in the first write command CMD_W1 is buffered in the write buffer WRITE BUFFER.

When the old write data is not buffered, the first core 213 may queue the received first write command CMD_W1 in a request queue 2191 of the working memory 219 (\textcircled{2}). The first core 213 may generate a first write descriptor DES_W1 based on the first write command CMD_W1 and store the first write descriptor DES_W1 in the descriptor buffer DESCRIPTOR BUFFER of the buffer memory device 220 (\textcircled{2}). Further, the first core 213 may store a write descriptor identifier DES ID, which is a storage position of the first write descriptor DES_W1, to match with the first write command CMD_W1 of the request queue 2191.

The data transmission block 225 may store the first write data WD1 received from the external apparatus 100 in the write buffer WRITE BUFFER of the buffer memory device 220 according to a control signal CTRL_dt provided from the first core 213 (\textcircled{2}). The data transmission block 225 may be included in the inside of the first core 213.

The first write descriptor DES_W1 may include the first buffering information of the first write data WD1, for example, a buffering address of the write buffer WRITE BUFFER in which the first write data WD1 is stored.

When the old write data is buffered, the first core 213 may confirm whether or not the flag within the write descriptor for the old write data is set.

When the flag is not set, the first core 213 may change the first buffering information of the write descriptor related to the old write data to the buffering address of the first write data WD1.

When the flag is set, the first core 213 may perform queuing for the first write command CDM_W1, generating and storing of the first write descriptor DES_W1, and buffering of the first write data WD1.

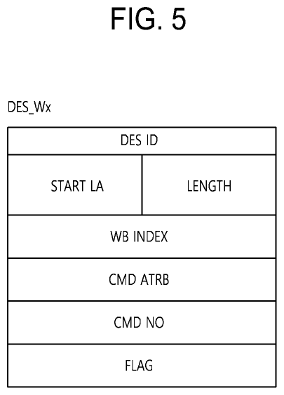

FIG. 5 is a diagram for describing a write descriptor according to an embodiment of the present disclosure.

Referring to FIG. 5, the write descriptor DES_Wx may include a write descriptor identifier field DES ID, an address field START LA and LENGTH, an index field WB INDEX, a command attribute field CMD ARTB, a command identifier field CMD NO, and a flag field FLAG.

An address of the descriptor buffer DESCRIPTOR BUFFER in which the write descriptor DES_Wx is stored may be stored in the write descriptor identifier field DES ID.

Start logical address START LA and length LENGTH information for the write command may be stored in the address field START LA and LENGTH.

The first buffering information, which is an address of the write buffer WRITE BUFFER in which the write data is stored, may be stored in the index field WB INDEX.

A type of the command may be stored in the command attribute field CMD ATRB. Regarding the write descriptor DES_Wx, a value indicating that the corresponding command is the write command may be stored in the command attribute field CMD ATRB.

An identification value for identifying the write command may be stored in the command identifier field CMD NO.

A value indicating whether or not the write data corresponding to the write descriptor DES_Wx is (or has been) transmitted to the storage medium 260 may be stored in the flag field FLAG.

The address field START LA and LENGTH, the index field WB INDEX, the command attribute field CMD ATRB, and the command identifier field CMD NO may be set by the first core 213, and the flag field FLAG may be set by the second core 215.

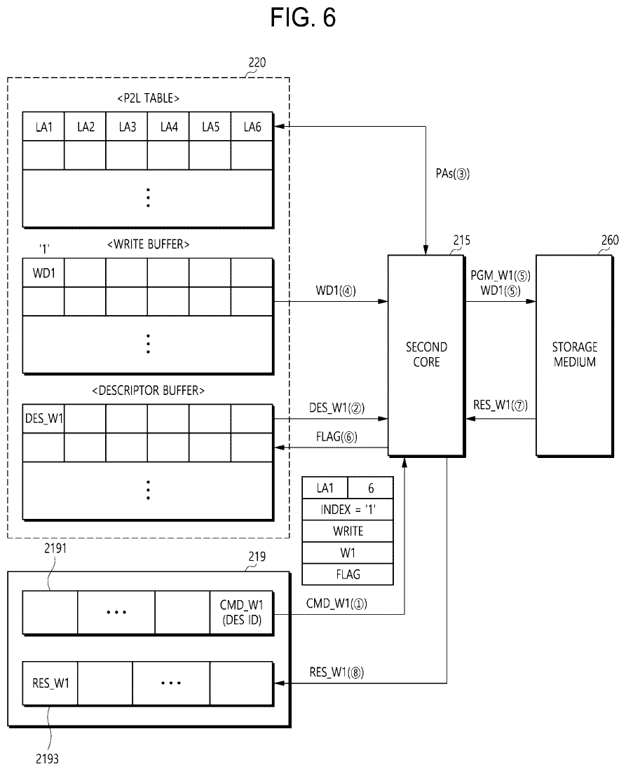

The working memory 219 may also include a response queue 2193, operations regarding which will be described herein below with respect to FIGS. 6 and 8.

FIG. 6 is a diagram for describing a second core according to an embodiment of the present disclosure.

Referring to FIG. 6, the second core 215 may periodically poll the request queue 2191 of the working memory 219. When the first core 213 queues the first write command CMD_W1 in the request queue 2191 as illustrated in FIG. 4, the second core 215 may dequeue the first write command CDM_W1 from the request queue 2191 (\textcircled{1}). In dequeuing, the first write descriptor identifier DES ID for the first write command CDM_W1 may be read.

The second core 215 may confirm that the command dequeued from the request queue 2191 is the write command, access the descriptor buffer DESCRIPTOR BUFFER according to the descriptor identifier DES ID, and read the first write descriptor DES_W1 (\textcircled{2}).

The second core 215 may interpret the first write descriptor DES_W1 and convert a logical address to be written to a physical address (\textcircled{3}). For example, when the start logical address START LA and length LENGTH information stored in the address field of the first write descriptor DES_W1 are ‘LA1’ and ‘6’, respectively, the second core 215 may sequentially store logical addresses ‘LA1 to LA6’ in the P2L table of the buffer memory device 220, and thus convert the logical addresses ‘LA1 to LA6’ to the corresponding physical addresses PAS.

The second core 215 may acquire the first buffering information, in which the first write data WD1 is stored, from the first write descriptor DES_W1 and generate the first buffering information as the second buffering information.

The second core 215 may generate a first program command PGM_W1 including the physical address PAs and the second buffering information.

When new second buffering information is provided from the verification circuit 217, the second core 215 may generate the first program command PGM_W1 including the physical address PAs and the new second buffering information provided from the verification circuit 217.

The second core 215 may access a position of the write buffer WRITE BUFFER corresponding to the second buffering information and read the first write data WD1 (\textcircled{4}), and provide the first program command PGM_W1 and the first write data WD1 to the storage medium 260 (\textcircled{5}).

The second buffering information may be a value corresponding to the write buffer index field WB INDEX of the first write descriptor DES_W1. For example, as illustrated in FIG. 6, when the value stored in the write buffer index field WB INDEX of the first write descriptor DES_W1 is ‘1’, the second core 215 may access the position corresponding to the index ‘1’ of the write buffer WRITE BUFFER and read the first write data WD1.

The second core 215 may set the flag field FLAG of the first write descriptor DES_W1 stored in the descriptor buffer DESCRIPTOR BUFFER to indicate that the first write data WD1 related to the first write command CMD_W1 is transmitted to the storage medium 260 (\textcircled{6}).

The storage medium 260 may program the first write data WD1 based on the first program command PGM_W1 received from the second core 215 and provide a first response signal RES_W1 including the program operation result (for example, a result of performing the program operation) to the second core 215 (\textcircled{7}).

The second core 215 may queue the first response signal RES_W1 received from the storage medium 260 in a response queue 2193 (for example, as shown in FIG. 4) of the working memory 219 (\textcircled{8}).

Accordingly, when a new write command for the same logical address as the logical address of the old write data buffered in the buffer memory device 220 is received, the first core 213 may confirm the flag included in the write descriptor of the old write data. When the flag is not set, the first core 213 may determine that the old write data is not yet transmitted to the storage medium 260 and change the first buffering information stored in the write descriptor of the old write data to a buffering address of new write data included in the new write command.

Accordingly, the second core 215 may generate the program command including the buffering address of the new write data included in the write descriptor as the second buffering information. Accordingly, the old write data may not be programmed in the storage medium 260 and the new write data may be programmed in the storage medium 260.

Before the second core 215 generates the program command and sets the flag, the first buffering information may be changed by the first core 213.

In preparation for inconsistency of the write data, the memory controller 210 may provide the correct buffering information to the storage medium 260 using the verification circuit 217.

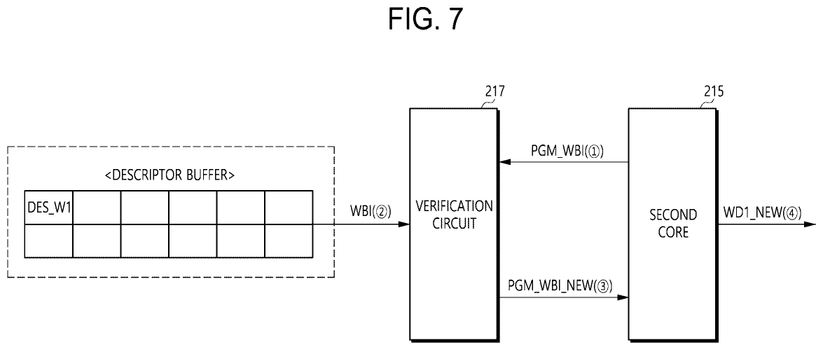

FIG. 7 is a diagram for describing a verification circuit according to an embodiment of the present disclosure.

Referring to FIG. 7, the verification circuit 217 may receive second buffering information PGM_WBI from the second core 215 (\textcircled{1}). The verification circuit 217 may read first buffering information WBI from the first write descriptor DES_W1 of the descriptor buffer DESCRIPTOR BUFFER (\textcircled{2}).

When the first buffering information WBI is different from the second buffering information PGM_WBI, the verification circuit 217 may provide a buffering address indicated by the first buffering information WBI as new second buffering information PGM_WBI_NEW to the second core 215 (\textcircled{3}).

The second core 215 may read new first write data WD1_NEW based on the buffering address indicated by the first buffering information WBI and provide the new first write data WD1_NEW to the storage medium 260 (\textcircled{4}).

FIG. 8 is a diagram for describing an operating method of a data storage apparatus according to an embodiment of the present disclosure.

When the first write command CMD_W1 and the first write data WD1 is received from the external apparatus 100 (\textcircled{1}), the first core 213 may confirm whether or not the write data of the old write command related to the same logical address as the logical address included in the first write command CMD_W1 is buffered in the buffer memory device 220.

When the old write data is not buffered, the first core 213 may queue the received first write command CMD_W1 in the working memory 219 (\textcircled{2}). The first core 213 may generate the first write descriptor DES_W1 based on the first write command CMD_W1 and store the first write descriptor DES_W1 in the buffer memory device 220 (\textcircled{2}). The first core 213 may store the first write data WD1 received from the external apparatus 100 in the buffer memory device 220 (\textcircled{2}). The first write descriptor DES_W1 may include the first buffering information WBI of the first write data WD1, for example, the buffering address of the buffer memory device 220 in which the first write data WD1 is stored.

When the old write data is buffered, the first core 213 may confirm whether or not the flag within the write descriptor for the old write data is set.

When the flag is not set, the first core 213 may change the first buffering information WBI of the write descriptor related to the old write data to the buffering address of the first write data WD1.

When the flag is set, the first core 213 may perform queuing for the first write command CMD_W1, generating and storing of the first write descriptor DES_W1, and buffering of the first write data WD1.

The second core 215 may dequeue the first write command CMD_W1 by polling the working memory 219 (\textcircled{3}).

The second core 215 may read the first write descriptor DES_W1 related to the first write command dequeued from the buffer memory device 220 (\textcircled{4}).

The second core 215 may generate the physical address PAs through address conversion based on the first write descriptor DES_W1, acquire the first buffering information WBI in which the first write WD1 is stored, and generate the first buffering information WBI as the second buffering information PGM_WBI. The second core 215 may generate the first program command PGM_W1 including the physical address PAs and the second buffering information PGM_WBI.

The verification circuit 217 may receive the second buffering information PGM_WBI from the second core 215 (\textcircled{5}). The verification circuit 217 may read the first buffering information WBI from the first write descriptor DES_W1 of the descriptor buffer DESCRIPTOR BUFFER (\textcircled{6}) from the buffer memory device 220.

When the first buffering information WBI is different from the second buffering information PGM_WBI, the verification circuit 217 may provide the buffering address indicated by the first buffering information WBI as the new second buffering information PGM_WBI_NEW to the second core 215 (\textcircled{7}). When the first buffering information WBI coincides with the second buffering information PGM_WBI, the verification circuit 217 may not provide the new second buffering information PGM_WBI_NEW to the second core 215.

The second core 215 may transmit the first program command PGM_W1 including the physical address PAs and the second buffering information PGM_WBI to the storage medium 260 (\textcircled{8}).

The second core 215 may access the position of the write buffer WRITE BUFFER corresponding to the second buffering information PGM_WBI or the new second buffering information PGM_WBI_NEW and read the first write data WD1 (\textcircled{9}) and provide the first write data WD1 to the storage medium 260 (\textcircled{10}).

The second core 215 may set the flag field FLAG of the first write descriptor DES_W1 to indicate that the first write data WD1 related to the first write command CMD_W1 is transmitted to the storage medium 260 (\textcircled{11}).

The storage medium 260 may program the first write data WD1 based on the first program command PGM_W1 received from the second core 215 and provide the first response signal RES_W1 including the program operation result to the second core 215 (\textcircled{12}).

The second core 215 may queue the first response signal RES_W1 in the response queue 2193 of the working memory 219 and then transmit the first response signal RES_W1 to the external apparatus 100 through the first core 213 (\textcircled{13}).

Accordingly, when the new write command for the same logical address as the old write data buffered in the buffer memory device 220 is received, the first core 213 may confirm the flag included in the write descriptor of the old write data. When the flag is not set, the first core 213 may determine that the old write data is not yet transmitted to the storage medium 260 and change the first buffering information stored in the write descriptor of the old write data to the buffering address of the new write data included in the new write command.

Accordingly, the second core 215 may generate the program command including the buffering address of the new write data included in the write descriptor as the second buffering information. Accordingly, the old write data may not be programmed in the storage medium 260 and the new write data may be programmed in the storage medium 260.

Before the second core 215 generates the program command and sets the flag, the first buffering information may be changed by the first core 213, but the correct buffering information may be provided to the storage medium 260 using the verification circuit 217.

The above described embodiments of the present disclosure are intended to illustrate and not to limit the present disclosure. Various alternatives and equivalents are possible. The present disclosure is not limited by the embodiments described herein. Nor is the present disclosure limited to any specific type of semiconductor device. Other additions, subtractions, or modifications are obvious in view of the present disclosure and are intended to fall within the scope of the appended claims.

What is claimed is:

1. A data storage apparatus comprising:
a storage medium; and
a memory controller configured to change, when a first write command including a same logical address as a logical address of old write data buffered in a buffer memory device is received, and the old write data is not yet transmitted to the storage medium, first buffering information including a first buffering address of the old write data to include a second buffering address of first write data related to the first write command, and generate a program command including, as second buffering information, the second buffering address.

2. The data storage apparatus of claim 1, wherein the memory controller is configured to:
transmit write data to the storage medium;
set a flag; and
confirm whether the write data is transmitted to the storage medium based on the flag.

3. The data storage apparatus of claim 1,
wherein the first buffering information is stored in a write descriptor, and
wherein the memory controller is configured to change the second buffering information to the first buffering information when the second buffering information included in the program command is different from the first buffering information included in the write descriptor related to the program command.

4. The data storage apparatus of claim 1, wherein the memory controller is configured to maintain the second buffering information when the second buffering information is a same as the first buffering information.

5. A memory controller comprising:
a first core configured to
buffer write data,
generate a write descriptor including first buffering information related to a buffering address of the write data, and
change, when old write data having a same logical address as a logical address included in a first write command is buffered, first buffering information of a write descriptor related to the old write data to include a buffering address of first write data related to the first write command based on a flag; and
a second core configured to
generate a program command including, as second buffering information, the buffering address of the first write data based on the write descriptor for the first write command,
transmit write data corresponding to the second buffering information to a storage medium, and
set the flag.

6. The memory controller of claim 5, wherein the first core is configured to skip generation of the write descriptor for the first write command.

7. The memory controller of claim 5, wherein when the flag is not set, the first core is configured to change the first buffering information to include the buffering address of the first write data related to the first write command.

8. The memory controller of claim 5, further comprising a verification circuit configured to provide the first buffering information to the second core when the second buffering information included in the program command is different from the first buffering information included in the write descriptor related to the program command, wherein the second core is configured to change the program command based on the first buffering information provided from the verification circuit.

9. The memory controller of claim 8, wherein when the second buffering information is a same as the first buffering information, the verification circuit is configured to control the second core to maintain the second buffering information.

10. An operating method of a data storage apparatus including a storage medium and a memory controller, the method comprising:
confirming, by the memory controller, whether old write data is transmitted to the storage medium in response to a first write command including a same logical address as a logical address of the old write data buffered in a buffer memory device
in response to a determination that the old write data is not yet transmitted to the storage medium, changing, by the memory controller, first buffering information including a first buffering address of the old write data to include a second buffering address of first write data related to the first write command; and
generating, by the memory controller, a program command including the first buffering address as second buffering information.

11. The method of claim 10, further comprising transmitting, by the memory controller, write data to the storage medium and setting a flag,
wherein the confirming includes confirming whether the old write data is transmitted to the storage medium based on the flag.

12. The method of claim 10, further comprising storing, by the memory controller, the first buffering information in a write descriptor; and
changing, by the memory controller, the second buffering information to the first buffering information in response to a determination that the second buffering information included in the program command is different from the first buffering information included in a write descriptor related to the program command.

13. The method of claim 12, further comprising maintaining, by the memory controller, the second buffering information in response to a determination that the second buffering information is a same as the first buffering information.
